(19) United States
(12) Patent Application Publication
(10) Pub. No.: US 2004/0016889 A1
(43) Pub. Date: Jan. 29, 2004

(54) Apparatus and method for generating an amplified effect in response to a periodic stimulus applied to asymmetrical hysteretic systems

(75) Inventors: Norman W. Schubring, Troy, MI (US); Joseph V. Mantese, Shelby Twp, MI (US); Adolph L. Micheli, Harrison Twp, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Delphi Technologies, Inc.

(21) Appl. No.: 10/202,225

(22) Filed: Jul. 25, 2002

(51) Int. Cl. G01J 1/58

(52) U.S. Cl. 250/458.1

(57) ABSTRACT

An apparatus for generating an amplified effect in an asymmetrical hysteretic system is disclosed. The asymmetrical hysteretic system comprises an internally-graded transponent, an energy source that drives the internally-graded transponent, and a small stimulus amplified by a gain factor of the internally-graded transponent. A method for generating an amplified effect in an asymmetrical hysteretic system is also disclosed.

### TECHNICAL FIELD

The present invention relates to asymmetrical hysteretic systems. More specifically, the present invention relates to asymmetrical hysteretic systems that have an amplified effect in response to a periodic stimulation.

### BACKGROUND OF THE INVENTION

Hysteretic systems can inherently store energy during and after an applied stimulation. The systems are regarded as being symmetrical in nature and perfectly balanced in response to a stimulus. It was surmised that a balanced hysteresis loop of a hysteretic system was the ideal form; any system that exhibited a deviation from a balanced hysteresis loop was considered to have an error, or an unknown, uninteresting, and valueless characteristic. For example, ferroelectrics that exhibit any asymmetry of a response (charge) to a stimulus (voltage) was usually attributed to simple non-ohmic contacts at the electrode interface surfaces. Generally, the asymmetrical ferroelectric devices were declared imperfect and disregarded.

However, true homogeneous ferroelectrics operate with strictly bound charge. These are insulators that store charge position (i.e. energy) after the stimulus has been removed. For example, all Ohm's Law devices, such as resistors, diodes, and transistors, operate with free charge. Consequently, there can be no static current for a conductive Ohm's Law device connected in a series with a nonconductive insulator. Therefore, a sound explanation needed to be established as to why a ferroelectric occasionally showed evidence of asymmetry in its hysteresis loop.

A ferroelectric that is internally-graded in composition exhibits an asymmetrical hysteresis loop. The unforeseen advantage in such asymmetry for a ferroelectric hysteretic system is that it generates a very usable amplified effect that may be expedited by a periodic stimulus. This is achieved by internally (i.e. functionally) grading the system. For example, ferroelectrics may have an internal gradient in: temperature, strain, electric field, or any combination thereof.

As seen in FIG. 15A, a graded dielectric hysteretic system in the form of a Sawyer-Tower circuit comprises a ferroelectric device 150 connected in series with a capacitor 152. An oscilloscope 154 is connected in parallel with the capacitor 152. In such an arrangement, the oscilloscope 154 provides a significant resistance when it is in parallel with the capacitor 152 and has a high impedance load.

As seen in FIG. 15B, a graphical representation of the stimulus (voltage, v) plotted against the response (charge, q) is measured by the oscilloscope 154 and represented by a balanced hysteresis loop 158. It is apparent that the hysteresis loop 158 develops a translation along the vertical axis, such as an amplified effect approximately equivalent to Q_{DC}, and a lateral translation from its centroid position near the origin approximately equivalent to V_{DC}.

The system described above is based on the principles of interally-graded ferroelectric materials, such as transpacitors and other graded ferroelectric devices, that are influenced by a third source of energy. The devices may be applied to sensors, such as pyroelectric detectors for night vision, or telecommunications, such as tunable filter materials for frequency delineation. For further reference, transpacitors are described in detail in U.S. Pat. No. 5,272,341 to Micheli et al. and U.S. Pat. Nos. 5,386,120 and 5,448,067 to Micheli. Pyroelectric sensors are described in detail in U.S. Pat. No. 6,294,784 to Schubring et al.

Although the discovery of an amplified effect in response to a periodic stimulus has been discovered and documented for an internally-graded dielectric hysteretic system, it is contemplated by the applicants that the discovery may apply to any internally-graded asymmetrical hysteretic system. Therefore, it is an objective of the applicants to show that any hysteretic system having asymmetry in its hysteresis loop will generate a useable amplified effect that may be expedited when a periodic stimulus(ii) is applied to an internally (i.e. functionally) graded system.

### SUMMARY OF THE INVENTION

Accordingly, one embodiment of the invention is directed to an asymmetrical hysteretic system, comprising an internally-graded transponent, an energy source that drives the internally-graded transponent and a small stimulus amplified by a gain factor of the internally-graded transponent.

Another embodiment of the invention is directed to an asymmetrical hysteretic system, comprising an internally-graded transponent, an energy source defined by a periodic stimulus that drives the internally-graded transponent, and a small stimulus that is amplified by a gain factor of the internally-graded transponent. The gain factor is approximately one-half the quantity of a DC stimulus multiplied by a DC response.

Another embodiment of the invention is directed to a method for generating an amplified effect for an asymmetrical hysteretic system. The asymmetrical hysteretic system comprises an internally graded transponent, a period stimulus, and a small stimulus. The method comprises the steps of driving the transponent with the periodic stimulus, generating a gain factor in response to the period stimulus acting on the transponent, amplifying the small stimulus with the gain factor, and producing an amplified output defined by the small stimulus and the gain factor.

### BRIEF DESCRIPTION OF THE DRAWINGS

The present invention will now be described, by way of example, with reference to the accompanying drawings, in which:

FIG. 1 is a graphical representation of a system having a single linear response to a single linear stimulus;

FIG. 2 is a graphical representation of a bilateral system having a single linear response to a single linear stimulus;

FIG. 3 is a graphical representation of a bilateral-nonlinear system having a single linear non-linear response to a single linear stimulus;

FIG. 4 is a graphical representation of a nonlinear, irreversible system having non-linear responses to a single linear stimulus;

FIG. 5 is a graphical representation of a full cycle, nonlinear, irreversible system having non-linear responses to a single linear stimulus;

FIG. 6A is a graphical representation of a hysteretic system defined by an asymmetrical hysteresis loop;

FIG. 6B is a graphical representation of an initial asymmetrical hysteretic system that ultimately transitions to a symmetrical hysteresis loop having an amplified effect;

FIG. 7 is a representative diagram of an asymmetrical hysteretic system comprising a transponent;

FIG. 8A is a representation of an internally-graded magnetic hysteretic system;

FIG. 8B is a graphical representation of the amplified effect of the internally-graded magnetic hysteretic system of FIG. 8A;

FIG. 9A is a representation of an internally-graded mechanical hysteretic system;

FIG. 9B is a graphical representation of amplified effect of the internally-graded mechanical hysteretic system of FIG. 9A;

FIG. 10A is a representation of another internally-graded mechanical hysteretic system;

FIG. 10B is a graphical representation of the amplified effect of the internally-graded mechanical hysteretic system of FIG. 10A;

FIG. 11A is a representation of another internally-graded mechanical hysteretic system;

FIG. 11B is a graphical representation of the amplified effect of the internally-graded mechanical hysteretic system of FIG. 11A;

FIG. 12A is a representation of an internally graded biological hysteretic system;

FIG. 12B is a graphical representation of the amplified effect of the internally-graded biological hysteretic system of FIG. 12A;

FIG. 13A is a representation of an internally-graded chemical hysteretic system;

FIG. 13B is a graphical representation of the amplified effect of the internally-graded chemical hysteretic system of FIG. 13A;

FIG. 14A is a representation of an internally-graded optical hysteretic system;

FIG. 14B is a graphical representation of the amplified effect of the internally-graded optical hysteretic system of FIG. 14A;

FIG. 15A is a representation of an internally-graded dielectric hysteretic system; and

FIG. 15B is a graphical representation of the amplified effect of the internally-graded dielectric hysteretic system of FIG. 15A.

### DESCRIPTION OF THE PREFERRED EMBODIMENT

The applicants have found that any hysteretic system having asymmetry in its hysteresis loop may be designed in such a way in order to generate a useable amplified effect when a periodic stimulus(ii) is applied to an internally—(i.e. functionally) graded system. Other stimuli, such as temperature, strain, etc., may also greatly affect the degree of the amplified effect and offer a variety of applications to other devices.

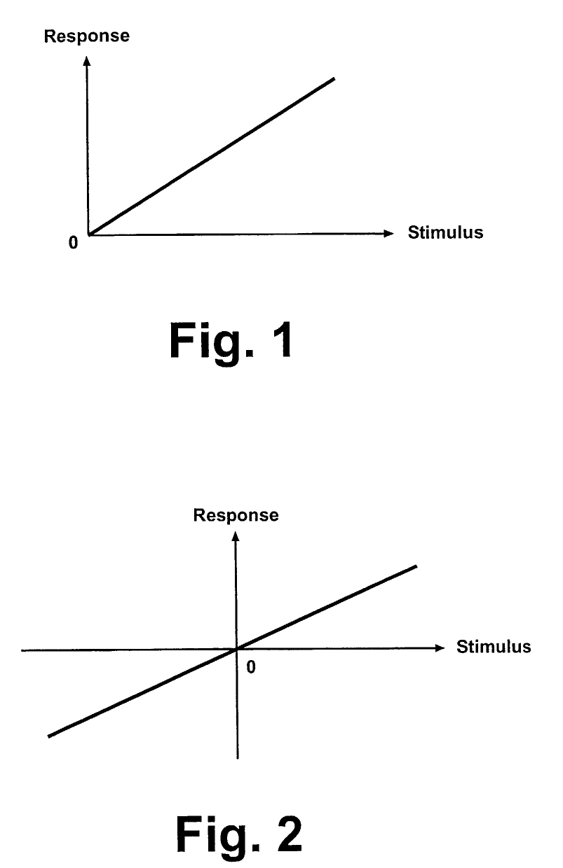

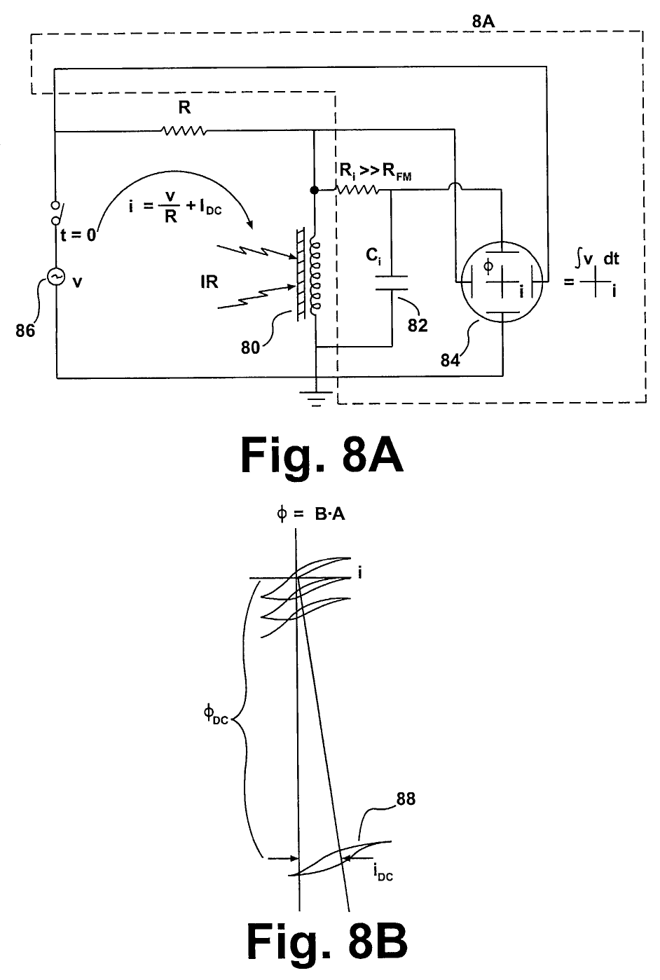

To understand where asymmetrical hysteretic systems fit in the progress of the complexity of the following systems described in FIGS. 8A-14A, a brief synopsis is in order. Referring to FIG. 1, any system shall always have at least one stimulus (represented on the x-axis) and one response (represented on the y-axis). For some degree of complexity, there may be multiple stimuli x(n), and/or multiple responses y(n), where n is an integer of one or more.

The integral of x*dy on an x-y plot is an area, which must necessarily represent a form of energy of some type (e.g. mechanical, electrical, magnetic, thermal, optical, acoustical, chemical, etc.). Because total energy is constant, all that can be done in a system is the movement of energy in one form or another. However, any energy movement always involves a cost. Some of the system's energy is exploited to reposition the remaining energy, or to change its form. In the case of a carrier system involving an external stimulus, such as an external power supply, the external power supply is usually considered to be an unaccountable “x source.”

The energy stored in a linear system may be a direct function of the stimulus source; when the stimulus is zero no energy is stored. As shown in FIG. 1, there is basically a single, linear, unilateral response to a single, linear stimulus. As shown in FIG. 2, if the system is bilateral, the behavior is balanced. Because stimulus is the independent variable, the energy of the system is always

{Stimulus d(Response)}.

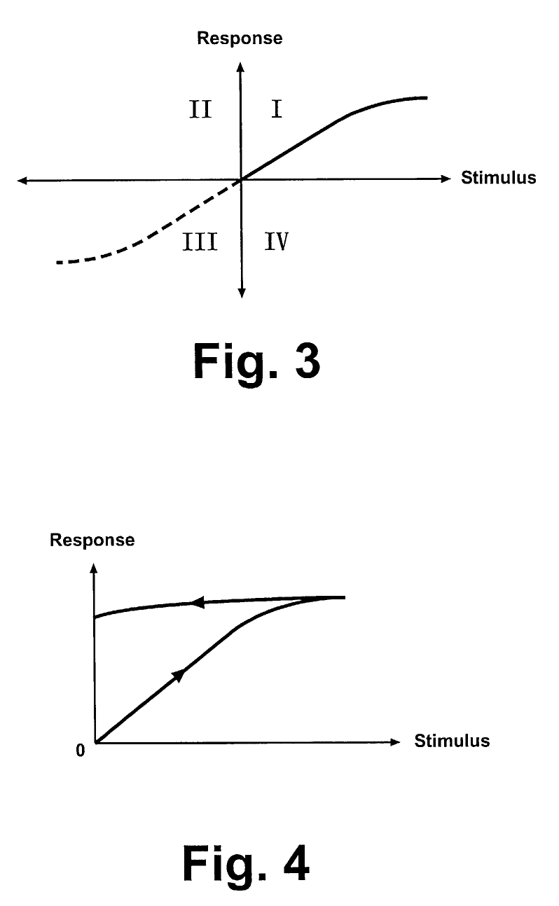

This fact becomes very important for the higher order, nonlinear, irreversible systems. As shown in FIG. 3, if the system is more complex, there may be nonlinearity or saturation in the first quadrant (I), or the first and third quadrants (I, III).

As seen in FIG. 4, the system may also be nonlinear and irreversible. Irreversibility means that the system cannot retrace the path in reverse, but will seek a new path and never return to zero at the zero stimulus. In this case, all the energy is not returned in retreating to the origin, but rather, it is stored in the system. The stored energy is an inherent quality of the system to statically store energy by remembering the last stimulus.

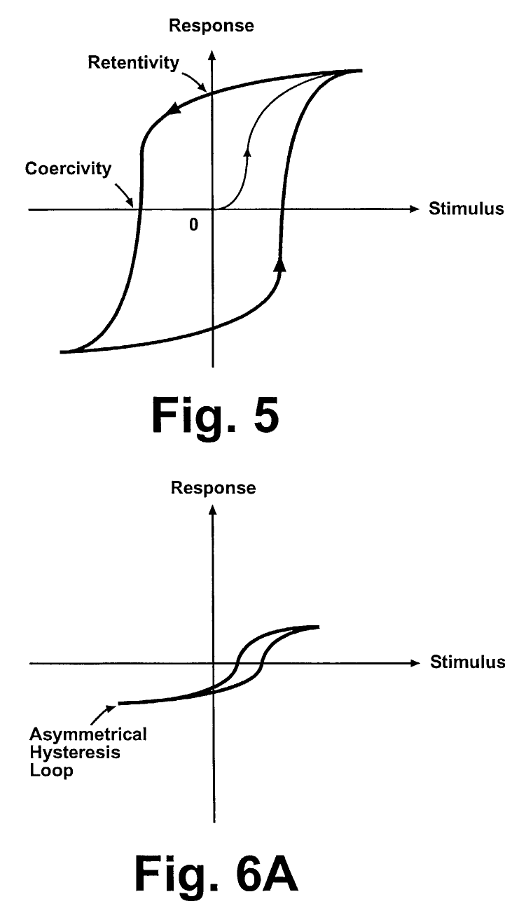

To complete the progression of symmetrical hysteretic systems, a full cycle, nonlinear, irreversible system is shown in FIG. 5. When the system is initially at rest and fully neutralized, a given stimulus creates an initial response that starts from the origin. However, once stimulated, the system memorizes the last stimulus, and retains some discrete values of the response.

For a single stimulus, the typical hysteresis is always counterclockwise. However, for multiple stimuli, the loop can be forced to reverse directions and go clockwise in the foregoing analysis. In a counterclockwise travel, the hysteresis indicates energy drawn into the system. For a clockwise travel, energy is released by the system. The only basic requirement is that the system can be able to permanently store energy. The latter portrayal constitutes all symmetrical hysteresis systems, where the response is not only nonlinear, but irreversible.

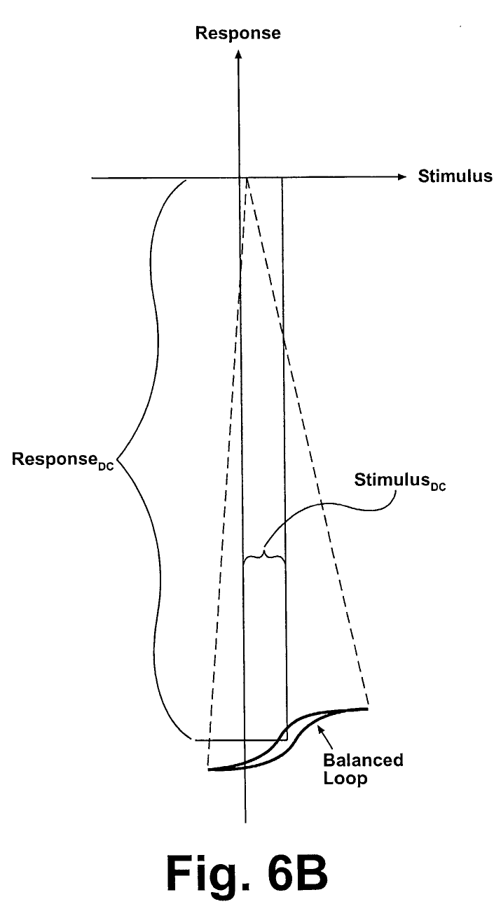

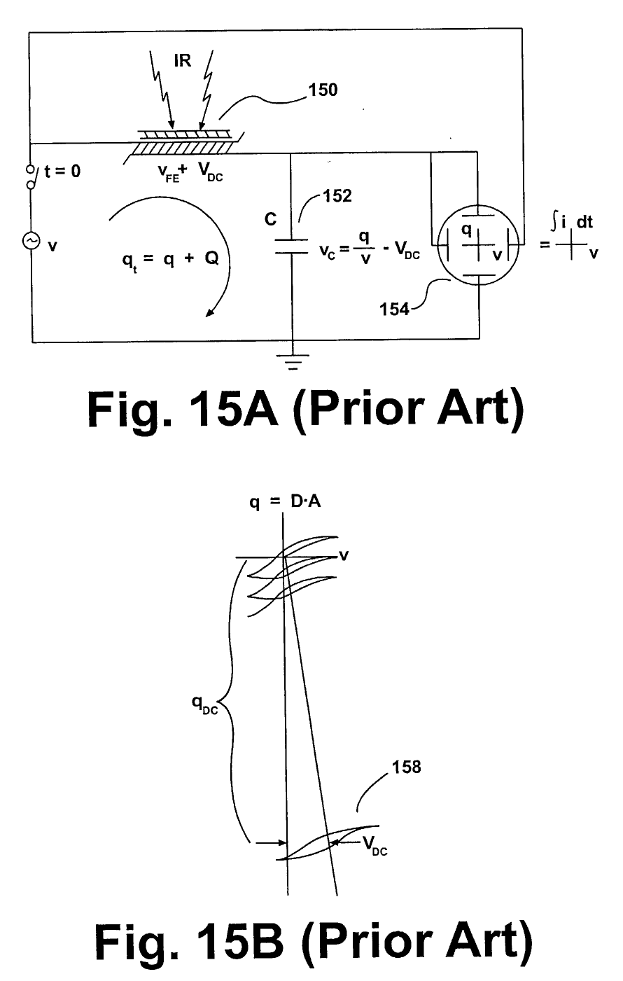

Referring now to FIGS. 6A and 6B, asymmetrical hysteretic systems that develop a significant amplified effect is a result of the asymmetry. In FIG. 6A, an instantaneous hysteresis loop for an asymmetrical system is idealized with a slight shift in the positive x-direction. The shift defines an initial, internal stimulus included in the system. For example, before a ferroelectric material 150 (FIG. 15A) is excited by a periodic stimulus, the ferroelectric material 150 already has an initial, internal stimulus, such as a voltage. Thus, in the absence of even exciting an asymmetrical system, a graphical depiction of an instantaneous hysteresis loop is shown shifted (FIG. 6A) in the positive x-direction so as to define the initial, internal stimulus. When driven by a symmetrical periodic excitation, the area of the asymmetrical hysteresis loop in quadrants I and IV is much greater than the area in quadrants II and III. Thus, the asymmetrical hysteresis loop is defined by an unbalanced storage of energy because the area of the loop in unbalanced.

In FIG. 6B, once the periodic stimulus is applied to the system, the hysteresis loop actually shifts over in the positive x-direction (stimulus) and develops an amplified effect in the negative y-direction (response). The amplified effect may be static in nature and very useable in response to the periodic stimulus. The overall shift in the x- and y-direction that defines the amplified effect is identified by a DC stimulus and a DC response. The amplified effect, which is hereinafter referred to as the gain factor (GF), is an area defined by:

GF=½(Stimulus_{DC}*Response_{DC}).

The GF amplification is very large and is graphically defined by an inversion of a negative slope (y=−mx+b). In an electrical sense, the GF amplification acts like a negative capacitor akin to a negative resistor in an active ohm's law device. However, it is important to note that the analogy to a negative capacitor does not limit the invention to electrical asymmetrical hysteretic systems, but rather, to all hysteretic systems that exhibits asymmetry.

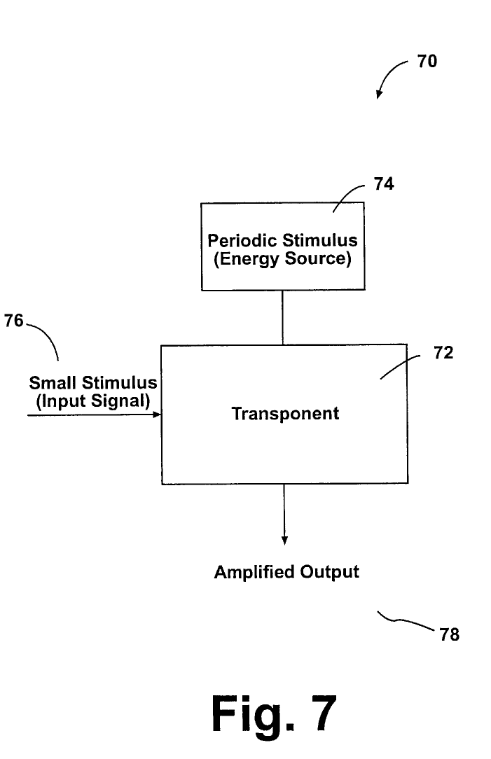

The physical representation of FIGS. 6A-6B is seen in FIG. 7. A transponent 72 sets the GF of an asymmetrical hysteretic system 70. The transponent 72 is part of an internally-graded structure comprising an energy source, such as a periodic stimulus 74. A small stimulus 76, such as an input signal, may be fed into the transponent 72. However, it is important to note that the small stimulus 76 may not necessarily be an input signal, and may be internally contained within the transponent 72 in the form of a small amount of internal energy. As described above in FIG. 6B, the amplified effect is expedited by the periodic stimulus 74, thus producing an amplified output 78 (e.g. a quantity of energy) defined by the GF (i.e. the system sources energy). The amplification is called a “transponent action.”

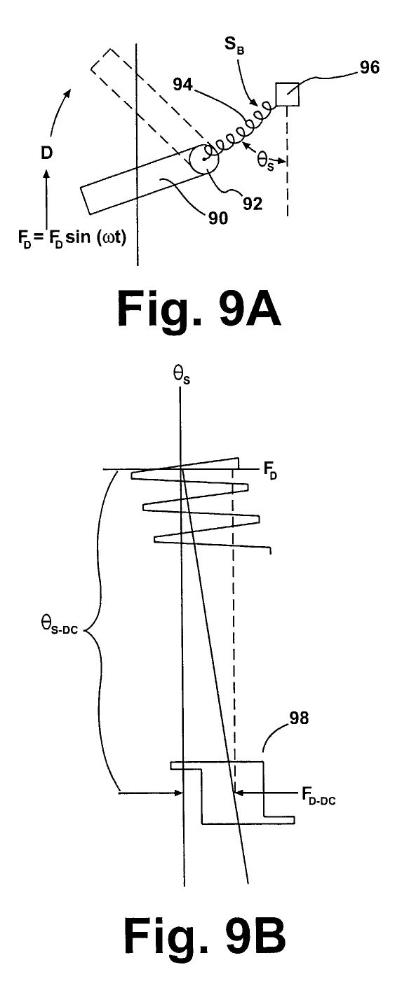

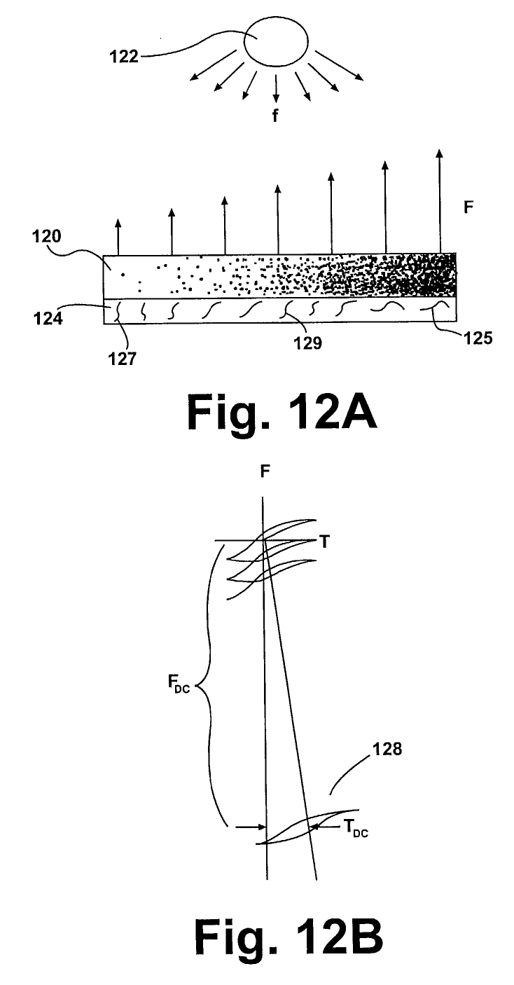

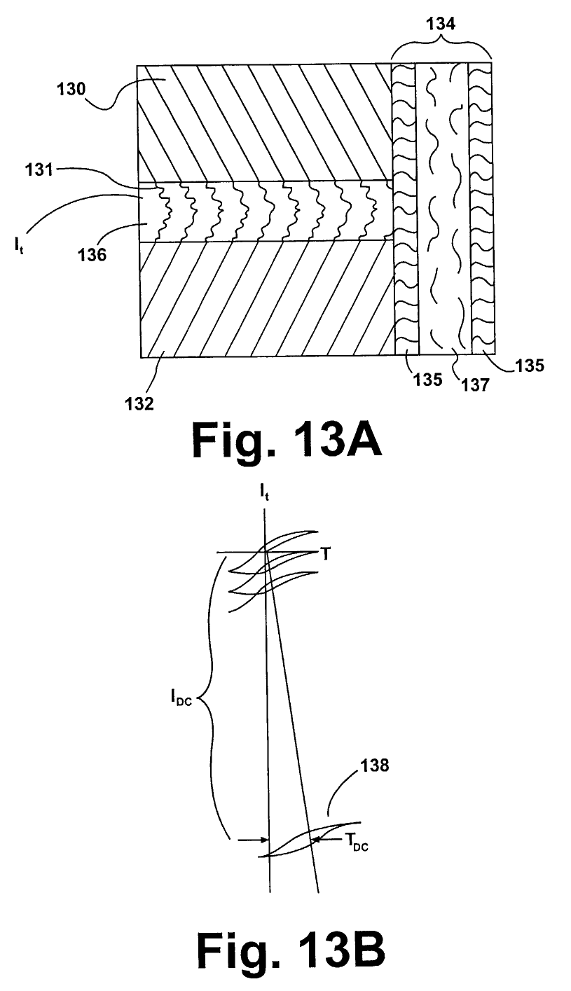

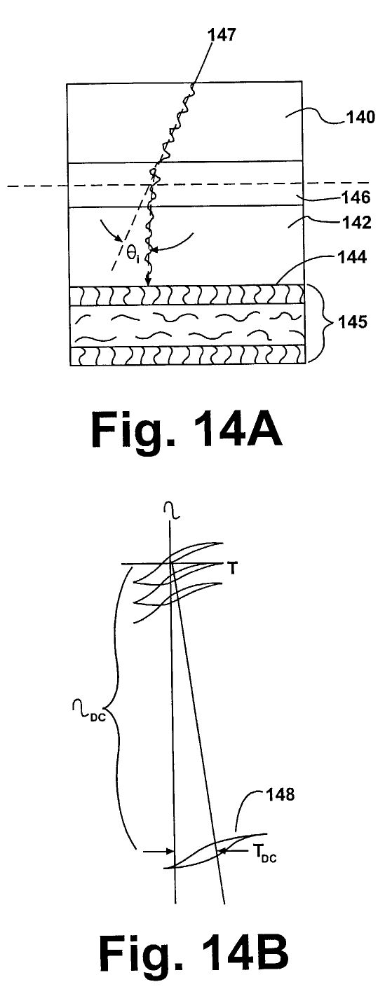

The transponent action is dependant upon the internal gradation of the system and may result from any small stimulus 76 such as current, force, heat, temperature, strain, etc. The amplified output 78 may be charge, magnetic flux, position movement, fluorescence, strain, etc. Thus, the transponent action may apply to any asymmetrical hysteretic system, such as functionally graded systems of all types of energy including: magnetic systems (FIG. 8A), mechanical systems (FIG. 9A-11A), chemical systems (FIG. 12A), biological systems (FIG. 13A), and optical systems (FIG. 14A), or any combination thereof with either static or dynamic stimulus(ii). Other functionally graded systems may also include: electrical, thermal, acoustical, environmental, etc.

As seen in FIG. 8A, a functionally graded magnetic system in a circuit comprised of a ferromagnetic device 80 is connected in parallel with an integrating capacitor 82. The portion of the circuit that measures the ferromagnetic device 80 is defined by the dashed line 8A and includes an oscilloscope 84 connected in parallel with the capacitor 82. In such an arrangement, the oscilloscope 84 provides a significant resistance and has a high impedance load when it is connected in parallel with the capacitor 82, a low- or zero-impedance alternating source 86, and the ferromagnetic device 80.

The system described above is based on the principles of internally-graded ferromagnetic materials, such as transductors and other graded ferromagnetic devices, that are influenced by a third source of energy. The devices may be applied to sensors, such as ultra-sensitive magnetometers and position sensors, or telecommunications, such as tunable resonators and circulators. A functionally graded magnetic system may be graded in magnetic polarization. The internal-grading of the system can be done chemically, by temperature, by strain, or by a magnetic field.

As seen in FIG. 8B, a graphical representation of the stimulus (current, i) plotted against the response (flux, Φ) is measured by the oscilloscope 84 and represented by a balanced hysteresis loop 88. When the flux, Φ, is measured, it will be weak and noisy. Therefore, an active current, i, is chosen for overcoming the noise. It is apparent that the hysteresis loop 88 develops a translation along the vertical axis, such as an amplified effect approximately equivalent to Φ_{DC}, and a lateral translation from its centroid position near the origin approximately equivalent to i_{DC}. The gain factor for the system is

GF=½(i_{DC}*Φ_{DC}).

Thus, the GF for the system is an amplified energy that would allow one to get a DC control of the response (Φ_{DC}) and use it for a sensor, such as ultra-sensitive magnetometer or position sensor, or in telecommunications, such as a tunable resonator or circulator.

As seen in FIG. 9A, a functionally graded mechanical system in the form of a mechanical switch comprises a toggle switch 90, a pivot point 92, an internal bias spring 94 having an angular dependant spring constant spring force bias, S_{B}, and a spring coupler 96. The spring force bias, S_{B}, relates to a spring constant, k, of the material, which also relates to the internal energy, E, of the spring including a position variable, x, of the switch (S_{B}=E=½ kx²). The position variable of the switch, x, can have two different, stable positions being a down position (shown by a solid line for switch 90), or an up position (shown by a dotted line for switch 90). The positioning variable, x, is further related to the angle of the spring, θₛ, which varies during movement of the switch 90.

In such an arrangement, the toggle switch 90 exhibits an asymmetrical hysteresis though the storage of internal energy in one direction by the internal bias spring 94. The internal bias spring 94 is seen by the system as a periodic stimulus. Because the internal bias spring 94 is biased in one direction, it is easier to operate the toggle switch 90 by applying force in the biased direction, D, with an oscillating force defined by F_{D}=Fₒsin(ωt) from a motor (not shown). Thus, the internal bias spring 94 can hinder or aid the movement of the toggle switch 90.

The system described above is based on the principles of internally-graded energy (i.e. energy as a function of an applied oscillating force) that has a gradient in force or potential. This particular functionally graded mechanical system may apply in a heavy-duty operation, such as rail switching. In other words, the advantage is not the snap action of the toggle switch 90, but rather the controlled movement of the toggle switch 90.

As seen in FIG. 9B, a graphical representation of the stimulus (oscillating force, F_{D}) plotted against the response (angle of the spring, θₛ) is represented by a balanced hysteresis loop 98. It is apparent that the hysteresis loop 98 develops a translation along the vertical axis, such as an amplified effect approximately equivalent to θ_{s-DC}, and a lateral translation from its centroid position near the origin approximately equivalent to F_{D-DC}. The gain factor for the system is

GF=½(F_{D-DC}*θ_{s-DC}).

Thus, the GF for the system is an amplified energy that would allow one to get a DC control of the response (θ_{s-DC}) and use it in a positioner application such as micropositioning or other heavy-duty operations.

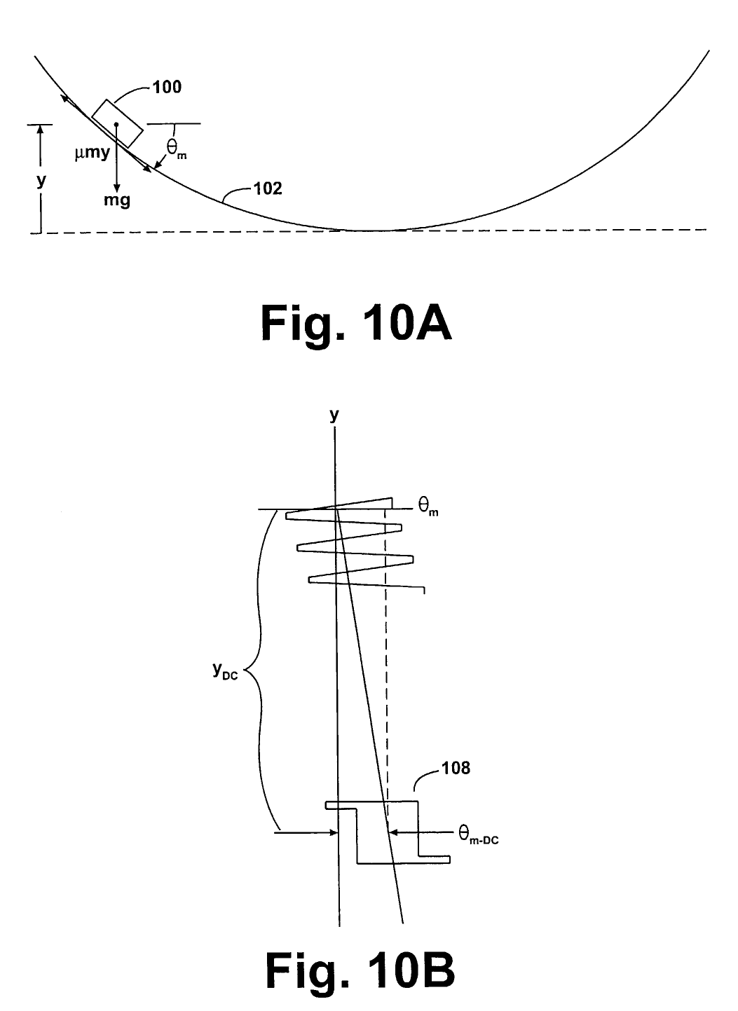

As seen in FIG. 10A, another functionally graded mechanical system in the form of a mass (m) 100 appears on a sloping surface 102, such as a half-pipe. The gradient of this system is the sloping surface 102. Because the system is graded, it is asymmetrical and incorporates the motion of the mass 100.

The system described above is based on the principles of internally-graded energy (i.e. energy as a function of gravity). The system may be applied to an automobile on a snow-covered hillside that is set at the threshold of static position. A symmetrical stimulus provided by gravity, g, acts as an amplifier. The acceleration provided by gravity, g, and the coefficient of friction, μ, operating on the mass (μmg) is constant. However, the acceleration provided by gravity, g, and the coefficient of friction, μ, operating on the mass is dependant upon the slope of the surface 102 at a particular point.

As seen in FIG. 10B, a graphical representation of the stimulus (angle of the mass 100 on the slope, θₘ) plotted against the response (vertical distance, y) is represented by a balanced hysteresis loop 108. Because there is a difference between static friction and sliding friction, if the mass 100 is moved back and forth and up and down, it will gradually oscillate in movement until it comes to a stop. The uphill movement of the mass 100 exhibits the asymmetrical hysteretic behavior expressed in the hysteresis loop 108. It is apparent that the hysteresis loop 108 develops a translation along the vertical axis, such as an amplified effect approximately equivalent to y_{DC}, and a lateral translation from its centroid position near the origin approximately equivalent to θ_{m-DC}. The gain factor for the system is

GF=½(θ_{m-DC}*y_{DC}).

Thus, the GF for the system is an amplified energy that would allow one to get a DC control of the response (y_{DC}) and use it in a positioning application such as an automobile on a snow-covered hillside that is set at the threshold of static position.

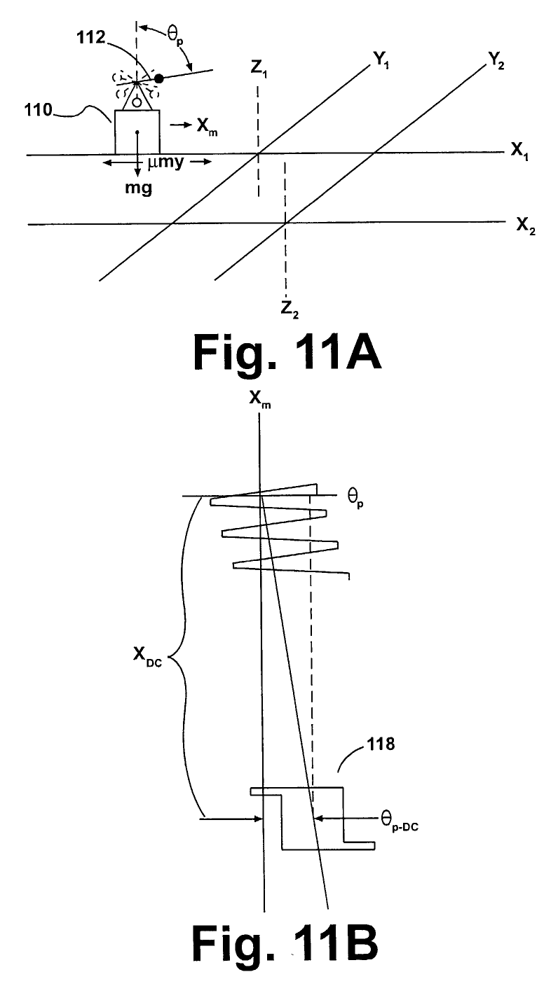

As seen in FIG. 11A, another functionally graded mechanical system comprises a mass (m) 110 with a moveable pendulum 112. The mass 110 is located on a graded environment, such as level surface X₁, so that is may move in a specified direction via the oscillatory movement of the pendulum 112. The pendulum 112 oscillates such that the mass 110 moves very slightly so that it creeps along the surface gradation of the level surface, X₁. Because the system is graded, it is asymmetrical and incorporates the motion of the mass 110.

The periodic stimulus is the pendulum 112, which for all practical purposes continues perpetually after being energized. The pendulum 112 represents an internal or external weight of the mass 110 that moves back and forth. The mass 110 is defined to be lighter than that of the pendulum 112. The overall extent of the weight difference between the mass 110 and pendulum 112 translates into the movement of the mass 110. Although a pendulum 112 is generally shown as the source of movement for the mass 110, the pendulum 112 may be an internal or external oscillator in the mass 110 that allows it to creep along towards its final position.

The system described above is based on the principles of internally-graded energy (i.e. energy as a function of gravity). The mechanical system may be applied to situations requiring precision control adjustments, such as positioning alignment. In the present system, a vertical force (mg) on the mass 110 that is below the threshold of sliding friction (μmg) is augmented by the oscillatory force of the pendulum 112. In this way, the system described above permits precision control alignment of a plane Z₁ with a plane Z₂. The advantage for this system is that real, exact positioning may be achieved by taking advantage of the energy that is stored in the pendulum 112.

Even though the system described above may be implemented for larger scale systems, the mass 110 and pendulum 112 may be very small such that they are designed to a microscale for a system that requires micropositioning. For example, in the semiconductor industry, the mass 110 may align planes Z₁, Z₂ in the range of microns, or even sub-microns, such as a quarter micron or two-tenths of a micron. This is accomplished by the very precise motion of the pendulum 112.

As seen in FIG. 11B, a graphical representation of the stimulus (angle of the pendulum, θₚ) plotted against the response (movement of the mass, Xₘ) is represented by a balanced hysteresis loop 118. It is apparent that the hysteresis loop 118 develops a translation along the vertical axis, such as an amplified effect approximately equivalent to X_{DC}, and a lateral translation from its centroid position near the origin approximately equivalent to θ_{p-DC}. X_{DC} is the position of the mass, and θ_{p-DC} is an internal definition of movement that the pendulum operates at. The gain factor for the system is

GF=½(θ_{p-DC}*X_{DC}).

Thus, the GF for the system is an amplified energy that would allow one to get a DC control of the response (X_{DC}) and use it in a positioning application, such as micropositioning for a semiconductor.

As seen in FIG. 12A, a functionally graded biological system comprises a unit of cells 120, a light source 122, and a temperature plate 124. In this system, the cells 120 are located over a horizontal plate, such as the temperature control plate 124, which is hereinafter referred to as a hot plate 124. The hot plate 124 may cycle through hot and cold temperatures, which are defined by a hot zone having horizontal lines 125 and a cold zone having vertical lines 127. The middle portion of the hot plate 124 is a neutral zone that is neither hot or cold and is defined by diagonal lines 129. The hot plate 124 drives the system and represents the periodic stimulus by providing a gradient in temperature.

The system described above is based on the principles of internally-graded biological activity. As shown above, the temperature gradient forms a gradient in the biological system, such as a gradient in biological activity. The biological activity is defined by a change in fluorescence intensity, F=Fₒsin(ωt), of the system having a periodic value. According to the FIG. 12A, the biological system tends to have a greater fluorescence at higher temperatures and a lower fluorescence at lower temperatures. As will be seen below, the temperature gradient causes the hot zone of the cells 120 to fluoresce more than the cold zone when they are struck with light, from the light source 122 having an incident flux with a periodic modulation, f=fₒ(sin(ωt).

The fluorescence, F, is a function of temperature and the incident flux, f. For example, when the temperature is lowered, the cells 120 shut down and the fluorescence, F, degrades to a larger degree. Conversely, when the temperature is raised slightly, the cells 120 become active and have a higher degree of fluorescence, F, under the incident flux, f. Other sources of light and heat may also contribute to the fluorescence, F, to some degree.

The system described above may be applied to cells 120 that fluoresce and that have a function of thermal energy, chemical energy, or some other form of energy. For example, if biological cells 120 are sensitive to a specific chemical environment, a certain drug may affect the fluorescence, F, of the cells 120 so that it may be detectable. If the fluorescence, F, that is detected, one can determine the amount of chemical existence in the biological cell 120. In another application, biological cells 120 may be killed with a form of radiation. If the net fluorescence, F, is identified, then the correct amount of radiation dosage can be determined for a specified amount of biological cells 120 that relate to the detected fluorescence, F.

As seen in FIG. 12B, a graphical representation of the stimulus (temperature of the hot plate, T) plotted against the response (fluorescence of the cells, F) is represented by a balanced hysteresis loop 128. The intensity of the fluorescence, F, may be measured by a charge-coupled detector. It is apparent that the hysteresis loop 128 develops a translation along the vertical axis, such as an amplified effect approximately equivalent to F_{DC}, and a lateral translation from its centroid position near the origin approximately equivalent to T_{DC}, the internal temperature of the system. The gain factor for the system is

GF=½(T_{DC}*F_{DC}).

Thus, the GF for the system is an amplified energy that would allow one to get a DC control of the response (F_{DC}) and use it in a biological application that has fluorescing cells that are excited by thermal energy or chemical energy.

As seen in FIG. 13A, a functionally graded chemical system comprises a first chemical 130, a second chemical 132, and a hotplate 134. The chemicals 130, 132 are located adjacent to the hotplate 134. Similar to the biological embodiment described above in FIG. 12A, the hot plate 134 may cycle through hot and cold temperatures, T, which are defined by a hot zone 135 comprising horizontal lines and a cold zone 137 comprising vertical lines. The driving source temperature, T, of the hot plate is defined by a periodic stimulus having a sinusoidal drive in temperature, T=Tₒsin(ωt) that provides a gradient in temperature.

The first chemical 130 and the second chemical 132 may be, for example, methanol and gasoline, respectively. The chemicals 130, 132 have different densities and a miscibility that is a function of temperature. At high temperatures, the chemicals 130, 132 are completely miscible. At low temperatures, the two chemicals 130, 132 are phase separated by an interface 136 where the chemicals 130, 132 are inter-diffused and tend to rest on top of each other. Generally, the interdiffusion chemicals 130, 132 is defined by the sharpness of the lines 131 in the interface 136. The interdiffusion 131 depends upon the overall temperature of the hot plate 134.

When the hot plate 134 cycles the temperature of the system, the interface 136 will change in size from large to small. The thickness, Iₜ, of the interface 136 is a function of the temperature and the effects of gravity, g, on the chemicals 130, 132. The local chemical energy content, ψ=ψₒ(g, Tₒ(sin(ωt)), is a function of temperature, Tₒ, and the characteristics of the chemical constituents 130, 132. Locally, the chemical concentration in the interface 136 determines the chemical reactivity.

The system described above is based on the principles of internally-graded chemical reactivity. An application of this system may be used to detect temperature or a third chemical that dramatically changes the properties of the interface region 136. The oscillating of the temperature in the system is not limited to a sinusoidal drive in temperature, but may be any periodic function.

As seen in FIG. 13B, a graphical representation of the stimulus (temperature of the hot plate, T) plotted against the response (interface thickness, Iₜ) is represented by a balanced hysteresis loop 138. It is apparent that the hysteresis loop 138 develops a translation along the vertical axis, such as an amplified effect approximately equivalent to I_{DC}, and a lateral translation from its centroid position near the origin approximately equivalent to T_{DC}, the internal temperature of the system. The gain factor for the system is

GF=½(T_{DC}*I_{DC}).

Thus, the GF for the system is an amplified energy that would allow one to get a DC control of the response (I_{DC}) and use it in a chemical application for detecting either temperature or a third chemical that dramatically changes the properties of an interface region of interacting chemicals.

As seen in FIG. 14A, a functionally graded optical system comprises a first medium 140, a second medium 142, and an interface 144, which is adjacent to a hot plate 145. The first medium 140 and the second medium 142 may be, for example, a liquid and a chemical, respectively, that have different modulations. Similar to the chemical system in FIG. 13A, the mediums 140, 142 have different densities and miscibilities that are a function of temperature, T. The driving source temperature of the hot plate is defined by a periodic stimulus having a sinusoidal drive in temperature, T=Tₒsin(ωt).

In this system, the mediums 140, 142 are located above the interface 144 and interact in a miscible zone 146. The miscible zone 146 is the gradient of the system in that it is a function of temperature of the hot plate interface 144. A light-ray 147, such as a laser beam, is scanned into the mediums 140, 142 that refracts at an angle, θ₁, which results in the light-ray 147 being incident upon the interface 144.

The index of refraction, η, is a function of the two mediums 140, 142, and the miscibility zone 146. Thus, the miscible zone 146 determines the index of refraction, η, at which the light-ray 147 bends, and the mediums 140, 142 determines the velocity at which the light-ray 147 travels through the mediums 140, 142.

The system described above is based on the principles of internally-graded chemical reactivity. The system may be applied to any device that requires modulation of the index of refraction, η, or the mediums that define the device to affect optical transmission or reflection (e.g. an oscillating prism).

As seen in FIG. 14B, a graphical representation of the stimulus (temperature of the hot plate, T) plotted against the response (index of refraction, η) is represented by a balanced hysteresis loop 148. It is apparent that the hysteresis loop 148 develops a translation along the vertical axis, such as an amplified effect approximately equivalent to η_{DC}, and a lateral translation from its centroid position near the origin approximately equivalent to T_{DC}, the internal temperature of the system. The gain factor for the system is

GF=½(T_{DC}*η_{DC}).

Thus, the GF for the system is an amplified energy that would allow one to get a DC control of the response (η_{DC}) and use it in an optical application for any device that requires modulation of the index of refraction, η, or the mediums that define the device to affect optical transmission or reflection.

The hysteretic systems described above in FIGS. 8A-14A (e.g. magnetic, mechanical, chemical, biological, and optical) having asymmetry in its hysteresis loop generates an amplified effect when a periodic stimulus(ii) is applied to an internally-graded hysteretic system. Other functionally graded hysteretic systems may also include: electrical, thermal, acoustical, environmental, etc. Although the electrical, thermal, acoustical, and environmental systems are not shown in a specific example, the claimed invention is not meant to be limited to only magnetic, mechanical, chemical, biological, and optical systems, but rather for any functionally graded hysteretic system having asymmetry in its hysteresis loop such that it may generate an amplified effect in response to a periodic stimulus(ii).

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. An asymmetrical hysteretic system, comprising:
an internally-graded transponent;
an energy source that drives the internally-graded transponent; and
a small stimulus amplified by a gain factor of the internally-graded transponent.

2. The apparatus according to claim 1, wherein the energy source is defined by a periodic stimulus.

3. The apparatus according to claim 1, wherein the small stimulus is defined by an input signal.

4. The apparatus according to claim 1, wherein the gain factor is approximately one-half the quantity of a DC stimulus multiplied by a DC response.

5. The apparatus according to claim 1, wherein the transponent is a ferromagnetic device.

6. The apparatus according to claim 5, wherein the energy source is a low-impedance alternating voltage source.

7. The apparatus according to claim 5, wherein the gain factor is approximately one-half the quantity of a DC active current multiplied by a DC flux.

8. The apparatus according to claim 1, wherein the transponent is a mechanical switch defined by a toggle, a pivot point, and an internal bias spring.

9. The apparatus according to claim 8, wherein the energy source is an oscillating force produced by a motor.

10. The apparatus according to claim 8, wherein the gain factor is approximately one-half the quantity of a DC oscillating force multiplied by a DC angle of the internal bias spring.

11. The apparatus according to claim 1, wherein the transponent is a mass on a sloping surface.

12. The apparatus according to claim 11, wherein the energy source is an acceleration of gravity acting on the mass.

13. The apparatus according to claim 11, wherein the gain factor is approximately one-half the quantity of a DC angle of the mass on the slope multiplied by a DC vertical distance of the mass.

14. The apparatus according to claim 1, wherein the transponent is a mass including an oscillating pendulum on a level surface.

15. The apparatus according to claim 14, wherein the energy source is the oscillatory movement of the pendulum.

16. The apparatus according to claim 14, wherein the gain factor is approximately one-half the quantity of a DC angle of the pendulum multiplied by a DC movement of the mass.

17. The apparatus according to claim 1, wherein the transponent is a biological system defined by a unit of cells, a light source, and a hot plate.

18. The apparatus according to claim 17, wherein the energy source is the light source.

19. The apparatus according to claim 17, wherein the gain factor is approximately one-half the quantity of a DC temperature of the hot plate multiplied by a DC fluorescence of the cells.

20. The apparatus according to claim 1, wherein the transponent is a chemical system defined by a first chemical, a second chemical, a hot plate, and an interface defined by a thickness.

21. The apparatus according to claim 20, wherein the energy source is the temperature of the hot plate defined by a sinusoidal drive in temperature.

22. The apparatus according to claim 20, wherein the gain factor is approximately one-half the quantity of a DC temperature of the hot plate multiplied by a DC interface thickness.

23. The apparatus according to claim 1, wherein the transponent is an optical system defined by a first medium, a second medium, a miscible zone that determines an index of refraction, and an interface adjacent to a hot plate.

24. The apparatus according to claim 23, wherein the energy source is the temperature of the hot plate defined by a sinusoidal drive in temperature.

25. The apparatus according to claim 23, wherein the gain factor is approximately one-half the quantity of a DC temperature of the hot plate multiplied by a DC index of refraction.

26. An asymmetrical hysteretic system, comprising:
an internally-graded transponent;
an energy source defined by a periodic stimulus that drives the internally-graded transponent; and
a small stimulus that is amplified by a gain factor of the internally-graded transponent, wherein the gain factor is approximately one-half the quantity of a DC stimulus multiplied by a DC response.

27. The apparatus according to claim 26, wherein the transponent is a ferromagnetic device.

28. The apparatus according to claim 27, wherein the energy source is a low-impedance alternating voltage source.

29. The apparatus according to claim 27, wherein the DC stimulus is a DC active current and the DC response is a DC flux.

30. The apparatus according to claim 26, wherein the transponent is a mechanical switch defined by a toggle, a pivot point, and an internal bias spring.

31. The apparatus according to claim 30, wherein the energy source is an oscillating force produced by a motor.

32. The apparatus according to claim 30, wherein the DC stimulus is a DC oscillating force and the DC response is a DC angle of the internal bias spring.

33. The apparatus according to claim 26, wherein the transponent is a mass on a sloping surface.

34. The apparatus according to claim 33, wherein the energy source is an acceleration of gravity acting on the mass.

35. The apparatus according to claim 33, wherein the DC stimulus is a DC angle of the mass on the slope and the DC response is a DC vertical distance of the mass.

36. The apparatus according to claim 26, wherein the transponent is a mass defined by an oscillating pendulum on a level surface.

37. The apparatus according to claim 36, wherein the energy source is the oscillatory movement of the pendulum.

38. The apparatus according to claim 36, wherein the DC stimulus is a DC angle of the pendulum and the DC response is a DC movement of the mass.

39. The apparatus according to claim 26, wherein the transponent is a biological system defined by a unit of cells, a light source, and a hot plate.

40. The apparatus according to claim 39, wherein the energy source is the light source.

41. The apparatus according to claim 39, wherein the DC stimulus is a DC temperature of the hot plate and the DC response is a DC fluorescence of the cells.

42. The apparatus according to claim 1, wherein the transponent is a chemical system defined by a first chemical, a second chemical, a hot plate, and an interface defined by a thickness.

43. The apparatus according to claim 20, wherein the energy source is the temperature of the hot plate defined by a sinusoidal drive in temperature.

44. The apparatus according to claim 20, wherein the DC stimulus is a DC temperature of the hot plate and the DC response is a DC interface thickness.

45. The apparatus according to claim 26, wherein the transponent is an optical system defined by a first medium, a second medium, a miscible zone that determines an index of refraction, and an interface adjacent to a hot plate.

46. The apparatus according to claim 45, wherein the energy source is the temperature of the hot plate defined by a sinusoidal drive in temperature.

47. The apparatus according to claim 45, wherein the DC stimulus is a DC temperature of the hot plate and the DC response is a DC index of refraction.

48. A method for generating an amplified effect for an asymmetrical hysteretic system, the asymmetrical hysteretic system comprising an internally graded transponent, a periodic stimulus, and a small stimulus, comprising the steps of:
driving the transponent with the periodic stimulus;
generating a gain factor in response to the periodic stimulus driving the transponent;
amplifying the small stimulus with the gain factor; and
producing an amplified output defined by the small stimulus and the gain factor.
